(19) United States
(12) Patent Application Publication
(10) Pub. No.: US 2014/0308561 A1
(43) Pub. Date: Oct. 16, 2014

(54) CURRENT TAP ELEMENT FOR AN ENERGY STORAGE MODULE

(71) Applicants: BAYERISCHE MOROREN WERKE AKTIENGESELLSCHAFT, Munchen (DE); DIEHL METAL APPLICATIONS GMBH, Berlin (DE)

(72) Inventors: Hubertus Goesmann, Auernheim (DE); Christoph Born, Munchen (DE); Harald Heck, Nurnberg (DE); Frank Warmuth, Borkheide (DE)

(73) Assignee: Bayerische Motoren Werke Aktiengesellschaft, Munchen (DE)

(21) Appl. No.: 14/357,525

(22) PCT Filed: Nov. 23, 2012
(86) PCT No.: PCT/EP2012/004860

§ 371 Date: May 9, 2014

(30) Foreign Application Priority Data
Nov. 24, 2011 (DE) 102011087038.5

(51) Int. Cl. H01M 2/22; H01M 2/32

(52) U.S. Cl. CPC H01M 2/22; H01M 2/32; H01M 2220/20
USPC 429/121

(57) ABSTRACT

The present invention refers to a current tap element for an energy storage module, comprising: a contact element made from a first metal for directly connecting to a pole of the energy storage module, a conductor element which is directly connected to the contact element and is made from a second metal differing from the first metal, an overmolded plastic covering which completely encloses the conductor element, and a connection in the plastic covering for contacting the conductor element.

The present invention refers to a current tap element for an energy storage module and to a high-voltage storage device with the energy module and the current tap element, particularly for an automotive vehicle.

In a high-voltage storage device, which is normally called battery, for the power supply of an automotive vehicle, energy storage modules are used for driving the vehicle, e.g. electric vehicles or hybrid vehicles. A respective energy storage module typically consists of a plurality of stacked storage cells. The individual storage cells contain electrochemical cells of the battery. The stack consisting of the individual storage cells is mostly clamped. Apart from the mechanical fixation of the modules relative to one another, clamping particularly serves to counteract deformation by gas pressure changes which during operation occur in the electrochemical cells arranged in the interior of the modules. The plurality of storage cells of the energy storage modules are electrically connected to one another. The voltage must be tapped at the poles of the energy storage module.

It is the object of the present invention to provide a current tap element for an energy storage module which, while being producible at low costs and easily mountable, enables a safe contacting of the energy storage module.

This object is achieved by the features of the independent claim. The dependent claims refer to preferred developments of the invention.

Hence, this object is achieved by way of a current tap element for an energy storage module, the current tap element comprising a contact element made from a first metal and a conductor element made from a second metal differing from the first metal. The contact element is configured for direct connection to a pole of the energy storage module. The conductor element is directly connected to the contact element. The expression “directly connected” stands for a connection without any intermediate elements within the scope of this application. This connection is electrically conductive. A material used for establishing the connection may however be disposed between the two directly connected elements. When the contact element and the conductor element are e.g. soldered, solder may be found between the two components, and this is nevertheless a direct connection. The pole of the energy storage module may be formed in different ways. For instance, the pole of the energy storage module may directly be a connection terminal of an electrochemical storage cell. As an alternative, it is also possible that the energy storage module comprises a plurality of individual electrochemical storage cells. The individual poles of said storage cells are then again combined to poles of the energy storage module. Moreover, the current tap element according to the invention comprises an overmolded plastic covering which completely encloses the conductor element. “Overmolded” means here that the plastic covering is extruded in an injection molding process directly onto the conductor element and partly also onto the contact element. Furthermore, a connection for contacting the conductor element is provided in said plastic covering. Preferably, the conductor element is guided up to the edge of the plastic covering, so that it can be contacted. The voltage is tapped from the conductor element via said connection.

Owing to the configuration of the current tap element according to the invention, the conductor element is protected from corrosion, and protection against contact, e.g. during installation of the battery or during maintenance work, is also provided in addition via the plastic covering. The current tap element is produced in a very fast and robust and also automatable manner owing to the injection molding technique employed.

In a preferred configuration, it is provided that the first metal has a lower electronegativity than the second metal. Particularly, it is provided that the first metal shows better welding properties than the second metal. As a result, the contact element can be directly welded to a metallic element of the energy storage module. Specifically, aluminum is predominantly used for the first metal. Copper is predominantly used for the second metal. No pure components of aluminum or copper, but different alloys are here primarily used. The alloy of the first metal then predominantly consists of aluminum; the alloy of the second metal predominantly consists of copper.

Furthermore, it is preferably provided that the contact element and the conductor element are welded or soldered to each other. This guarantees the contact between the two elements within the plastic covering.

Moreover, preferably the plastic covering tightly encloses the conductor element for protection against corrosion. Just the contact element projects out of the plastic covering. The plastic covering preferably tightly seals around the contact element over the whole circumference. This means that the plastic covering directly lies on the contact element. As a result, no additional seal or no additional sealing material is needed between contact element and plastic covering, and a situation is prevented where liquid advances along the contact element towards the conductor element. Likewise, the plastic covering tightly seals with the conductor element in the area of the connection, so that no additional sealants have here to be used either. Owing to this sealing with the plastic covering an additional surface finishing especially of the conductor element is avoided at the same time. This lowers the manufacturing costs. The problems posed by aging sealants, which have so far been known, are here no longer relevant.

In a further advantageous configuration, it is provided that the contact element and the conductor element are configured to be plate-shaped. Specifically, the two elements are manufactured as punched and bent parts. The contact element and the conductor element lie flat on each other within the plastic area. This creates an overlap or intersection region. In this region the two elements can be easily connected to each other, and conductivity between contact element and conductor element is ensured.

Furthermore, the invention comprises a high-voltage battery for power supply, particularly of an automotive vehicle. Said high-voltage battery comprises at least one energy storage module with a plurality of electrochemical storage cells and at least one current tap element as has just been described. The contact element of the current tap element is either welded or soldered to a pole. The conductor element is contacted on the connection via a cable of the high-voltage battery. The advantageous configurations described within the scope of the current tap element of the invention are advantageously used in a corresponding manner on the high-voltage battery according to the invention.

It is particularly provided that plural connection terminals of different storage cells are interconnected by means of so-called cell connectors. The contact element is then connected, particularly welded or soldered, to one of the cell connectors.

The invention shall now be explained in more detail with reference to the accompanying drawing.

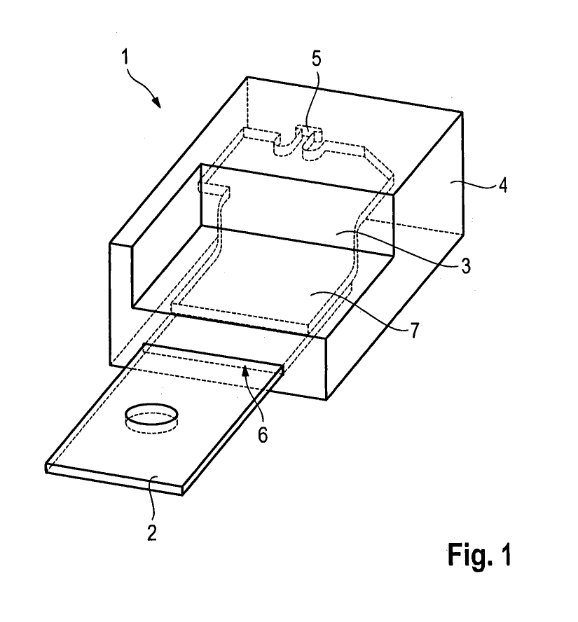

FIG. 1 shows a current tap element of the invention according to an embodiment.

FIG. 1 shows a current tap element 1 comprising a contact element 2, a conductor element 3 and an overmolded plastic covering 4. The contact element 2 and the conductor element 3 are both configured to be plate-shaped. The contact element 2 and the conductor element 3 overlap each other in an illustrated overlap region 7. In this overlap region 7, the conductor element 3 lies flat on the contact element 2. Furthermore, the two elements 2, 3 are welded to each other in the overlap region 7.

The conductor element 3 is completely enclosed by the plastic covering 4. The overlap region 7 is here fully positioned within the plastic covering 4, so that at an exit point 6 the contact element 2, and not the conductor element 3, projects out of the plastic covering 4. At this exit point 6, the plastic covering 4 tightly seals on the contact element 2 over the whole circumference. It is thereby avoided that liquid can pass via the contact element 2 inwards to the conductor element 3.

A connection 5 is positioned on the rear side of the current tap element 1. The plastic covering 4 tightly seals with the conductor element 3 also at this point of the connection 5. The conductor element 3 can be contacted via the connection 5.

The region of the contact element 2 which is not enclosed by the plastic covering 4 serves the connection to a pole of an energy storage module.

The contact element 2 predominantly consists of aluminum. The conductor element 3 predominantly consists of copper. Copper is used for the conductor element 3 because of its excellent conductivity. The aluminum of the contact element 2 is particularly well suited for welded joints.

### LIST OF REFERENCE NUMERALS

1 Current tap element

2 Contact element

3 Conductor element

4 Plastic covering

5 Connection

6 Exit point

7 Overlap region

1. A current tap element for an energy storage module, comprising:
a contact element made from a first metal for directly connecting to a pole of the energy storage module,
a conductor element which is directly connected to the contact element and is made from a second metal differing from the first metal,
an overmolded plastic covering which completely encloses the conductor element,
a connection in the plastic covering for contacting the conductor element.

2. The current tap element according to claim 1, wherein the first metal has a lower electronegativity than the second metal.

3. The current tap element according to claim 1, wherein the first metal consists predominantly of aluminum.

4. The current tap element according to claim 1, wherein the second metal consists predominantly of copper.

5. The current tap element according to, the contact element and the conductor element are welded or soldered to each other.

6. The current tap element according to claim 1, wherein the plastic covering tightly encloses the conductor element for protection against corrosion.

7. The current tap element according to claim 1, wherein that the contact element projects out of the plastic covering, and the plastic covering tightly seals on the contact element over the whole circumference, without any additional seals.

8. The current tap element according to claim 1, wherein the contact element and the conductor element are configured to be plate-shaped, particularly as punched and bent parts, with the contact element and the conductor element lying flat on each other in the plastic covering.

9. A high-voltage storage device for power supply, particularly of an automotive vehicle, comprising:
an energy storage module with a plurality of electrochemical storage cells, and
at least one current tap element according to any one of the preceding claims, wherein the contact element is connected, particularly welded or soldered, to at least one pole of the energy storage module, and
at least one cable connected to the connection on the conductor element.

10. The high-voltage storage device according to claim 9, wherein plural connection terminals of different storage cells are connected to one another by means of cell connectors, and the contact element is directly connected to one of the cell connectors.
